(19) United States
(12) Patent Application Publication
(10) Pub. No.: US 2005/0138603 A1
(43) Pub. Date: Jun. 23, 2005

(54) Componentization method for reengineering legacy system

(76) Inventors: Jung Eun Cha, Daejeon (KR); Chul Hong Kim, Daejeon (KR); Young Jong Yang, Daejeon (KR); Hyeon Soo Kim, Daejeon (KR)

Correspondence Address: PIPER RUDNICK LLP, P. O. BOX 9271, RESTON, VA, 20195, US

(21) Appl. No.: 10/986,875

(22) Filed: Nov. 15, 2004

(30) Foreign Application Priority Data
Dec. 22, 2003 (KR) 10-2003-0094802

(51) Int. Cl. G06F 9/44

(52) U.S. Cl. 717/120

(57) ABSTRACT

The present invention proposes a Magic and Robust Methodology Integrated-Reengineering (MaRMI-RE), which is a reengineering methodology defining a process including procedures and techniques for a componentization of legacy systems and work products generated during the process. A continuous evolution model for the legacy systems proposed in the present invention enables the legacy systems to be systematically transformed into component systems capable of smoothly complying with new requirements, thus maximizing productivity and efficiency of the legacy systems with respect to potential business and system change requirements.

### FIELD OF THE INVENTION

The present invention relates to technologies of reengineering legacy systems, including core logic of work, into component systems so that legacy systems can continue to be developed to comply with varying business and technical environments; and, more particularly, to a reengineering methodology which presents procedures, techniques and work products required to systematically transform legacy systems into component systems.

### BACKGROUND OF THE INVENTION

Most legacy systems have many problems to accommodate new technologies, or to be expanded or changed in accordance with complicated business requirements, since they are lack of standardization, openness, distributed architecture, and et al. Therefore, it is necessary to reengineer the legacy systems to maximize the utility thereof as an important asset of an organization, and thereby to meet variations in system environment, such as an emergence of new Information Technology (IT), various modifications of business information models, and a rapid increase in complexity of processing logics.

That is, in order to utilize a legacy system as a reusable asset having the core value to an organization, it is required to reengineer the legacy system into a new target system having systematic architecture. Only by reengineering, the understandability and reusability of the system are improved, a flexible maintenance structure can be constructed, and thus a system evolution model capable of accommodating later system variations can be obtained. In particular, the necessity of reengineering legacy systems into component-based systems with better design construction and architecture has been further emphasized, as the Internet becomes ubiquitous not only as an information sharing medium for people and organizations but also as a core technology for businesses, and as Component Based Development (CBD) based on pre-developed interoperable independent components becomes the dominant software (S/W) development paradigm.

However, conventional reengineering methodologies are not provided with support systems and standard guidelines allowing users to select or repeat reengineering procedures and techniques to satisfy their intentions, and therefore it is unavoidable to depend on users' subjective judgments at the time of important decision. Further, conventional and typical reengineering support tools and techniques emphasized a research on re-documentation techniques and static analysis that analyzes data flow or control flow based on source code to provide metrics. Therefore, it has been impossible to support establishing strategic reengineering plans and systematically developing the strategic plans into architectures that are suitable for a target system. Moreover, from the standpoint of a methodology, insufficient efforts have been made to concretely define the procedures and techniques of reengineering, so that a great number of organizations have repeatedly undergone similar trial and error in promoting reengineering projects. Recently, there have been attempts to overcome the above limitations through architecture-based reengineering technologies including pattern, framework, component, etc. However, there is much difficulty in procedures and techniques for systematically expressing and mapping knowledge about a business area on a system.

As a prior research related to reengineering, an “apparatus and method for generating components through extraction of design patterns from legacy system” disclosed in Korean Patent Publication No. 2003-0056295 proposes an apparatus and method, which can generate components having high interoperability and reusability from a legacy system by extracting design patterns from the design information of source code of the legacy system, structuring the source code on the basis of the design patterns and packaging the structured source code in the form of components.

Further, Korean Patent Publication No. 2003-0050621 (U.S. Pat. Publication No. 2003-0115025) relates to a “method and apparatus for wrapping existing procedure oriented program into component based system”. This publication discloses an identification algorithm identifying a function capable of being reused in an existing system, in which a user adjusts the weighting value of basic constituent elements on the basis of only general knowledge of a system such as use case without detailed knowledge about the system, so that a business logic is identified easily in top-down, and that a workflow of the system is identified in bottom-up to component wrap the identified business logic, thereby generating automatically the necessary constraint condition and the external interface. However, these conventional reengineering technologies provide only a specific technique which can be applied to a legacy system implemented in a specific language, and do not provide guidelines about reengineering processes, techniques and work products from a general standpoint.

As a conventional reengineering methodology that has been most widely referred to, there is Common Object-based Reengineering Unified Model II (CORUM II) that is developed at the Carnegie Mellon University (CMU) Software Engineering Institute (SEI). This methodology collects and arranges requirements from various standpoints to integrate architecture-based reengineering tools with code-based reengineering tools, and provides a framework required to prepare solutions that meet the requirements. It presents an integrated model of an architecture-based reengineering process and a forward engineering process. However, this method presents neither a detailed work process that is concretely applicable to the execution of a reengineering project, nor the guidelines and techniques of tasks that are required for the execution of the process. That is, architecture reengineering has been discussed only from an abstract standpoint in the model. Further, Mission ORiented Architecture Legacy Evolution (MORALE), developed at the Georgia Institute of Technology to improve a system by reflecting a new requirement (user-configurable view) in Mosaic Web browser, detects and effectively analyzes risk elements for the initial change of the evolution of the system, and then extracts components that can be used in a new system, with an emphasis on the mission of an organization rather than technical elements.

However, according to most of the above-described research, a reengineer is charged with a risk of information loss or deformation, which may occur during the transformation of the legacy system into a target system, without a support from systematized task procedures or work products. Therefore, it is difficult to accomplish a reengineering project if a precise reengineering vision or strategy is not provided, because information on legacy code can be analyzed ambiguously from different standpoints. Accordingly, a reengineering methodology, capable of providing processes and techniques to systematically transform and integrate a large-scale legacy system into a component-based system, is required.

### SUMMARY OF THE INVENTION

It is, therefore, an object of the present invention to provide a componentization method for reengineering a legacy system which supports a consistent process for constructing an organization's desired target system, an establishment of a strategy based on analysis, and detailed work products and techniques, so that the assets of a legacy system can be sufficiently utilized for constructing the target system, thus minimizing the semantic difference, and continuously maintaining and improving the value of the legacy system through transformation into a new target system.

In accordance with the present invention, there is provided a componentization method for reengineering a legacy system, including: a) a planning phase of establishing a componentization strategy and a process plan of the legacy system for the reengineering; b) a reverse engineering phase of analyzing program information of the legacy system and recovering functional information and architecture information; c) a componentization phase of extracting components from the legacy system, establishing target architecture, and designing and implementing components to comply with the target architecture; and d) a delivery phase of delivering transformed components which a user has approved after a forward engineering method.

That is, the present invention, in a reengineering planning phase, establishes an improved architecture, which is an ideal model for a target system to be produced as the result of the execution of reengineering through sufficient analysis from the standpoint of technology, business and maintenance of a legacy system, establishes a reengineering strategy that is a detailed approaching method to successfully accomplish a reengineering project, and defines an optimal reengineering process suitable for the capability of an organization on the basis of the established strategy. Further, in a reverse engineering phase, the present invention analyzes and recovers program, design, and architecture information about the legacy program itself in accordance with the established strategy, thus processing the information in an abstract form that can be effectively used in a later componentization phase. Then, in the componentization phase, the present invention extracts, identifies and evaluates components so as to transform the work products of the above-performed activity tasks into a component-based target system for a target environment, establishes system architecture for the target system, and designs, develops, and evaluates the components to meet a target platform, thus performing an actual task for constructing a component-based system.

### BRIEF DESCRIPTION OF THE DRAWINGS

The above and other objects and features of the present invention will become apparent from the following description of a preferred embodiment given in conjunction with the accompanying drawings, in which:

FIG. 1 shows a conceptual view of a componentization methodology for a legacy system, MaRMI-RE in accordance with the preferred embodiment of the present invention;

FIG. 2 describes a meta model configuration of the componentization methodology for a legacy system, MaRMI-RE in accordance with the preferred embodiment of the present invention;

FIG. 3 illustrates entire activities of the MaRMI-RE in accordance with a preferred embodiment of the present invention;

FIG. 4 offers a deployment process of the MaRMI-RE in accordance with the preferred embodiment of the present invention;

FIG. 5 provides a view showing activities and tasks constituting a planning phase of FIG. 3;

FIG. 6 presents a view showing activities and tasks constituting a reverse engineering phase of FIG. 3; and

FIG. 7 offers a view showing activities and tasks constituting a componentization phase of FIG. 3.

### DETAILED DESCRIPTION OF THE PREFERRED EMBODIMENT

A preferred embodiment of the present invention will now be described in detail with reference to the accompanying drawings.

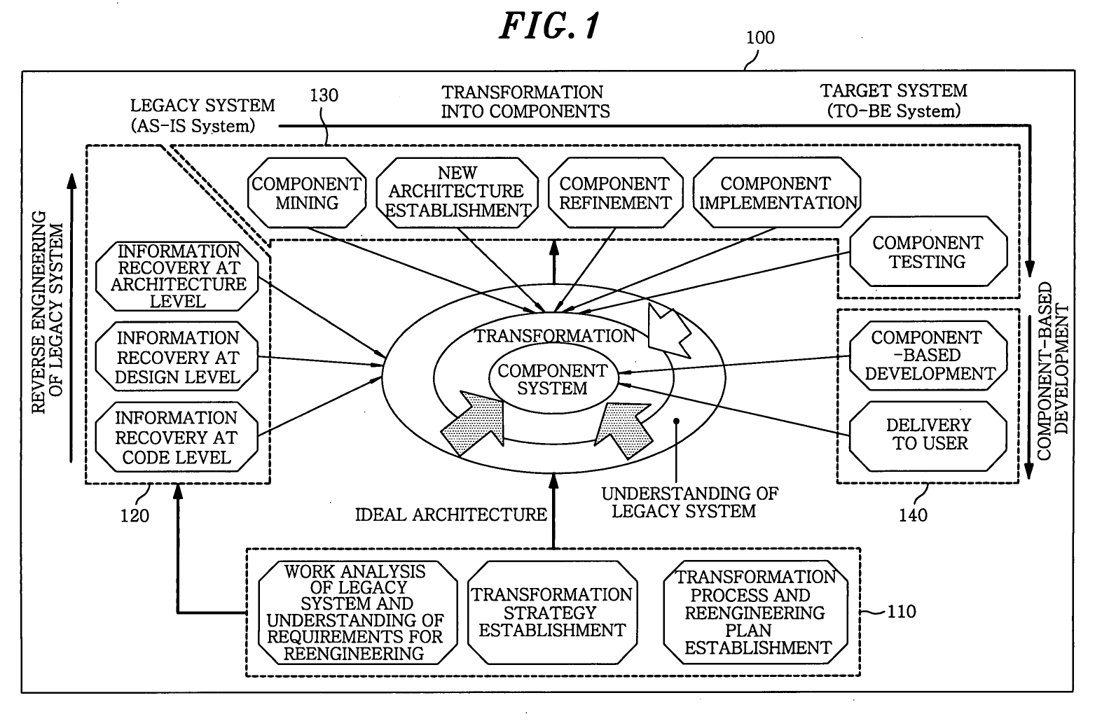

FIG. 1 illustrates a view showing a conceptual model 100 of a Magic and Robust Methodology Integrated-Reengineering (MaRMI-RE), which is an architecture-based componentization methodology for reengineering a legacy system, in accordance with a preferred embodiment of the present invention.

The MaRMI-RE is a component-based reengineering methodology to transform an “AS-IS model”, which a legacy system has, into a “TO-BE model”, which a target system includes, and is an architecture-based reengineering methodology capable of accommodating temporary change requirements. Further, the MaRMI-RE provides a development process based on an architecture oriented to the component-based development, which is capable of customizing a reengineering process in parallel and selectively, unlike a sequential and synchronized development process as in the case of a conventional methodology, thus supporting continuous expansion, assembly and customization on the basis of target architecture.

Further, the MaRMI-RE systematically transforms a legacy system, which has a short lifespan due to a high maintenance cost, greatly deteriorating productivity and efficiency, into a component-based system capable of accommodating various modern requirements. Therefore, the MaRMI-RE enables to continuously reuse the high value of the legacy system as an asset of an organization, and to guarantee a continuous development process according to the evolution of the system, thus providing a client's desired high quality service at a suitable time.

That is, the present invention provides the MaRMI-RE, which is a reengineering methodology that provides processes and techniques required to systematically transform and integrate a large-scale legacy system into a component-based system. Further, with reference to an initially established ideal architecture, the reengineering methodology proposed in the present invention analyzes and recovers the architecture information of the legacy system, establishes target architecture suitable for a system environment complying with the actual target of an organization as a result of the analysis and recovery, extracts and develops components, and allows the components to correspond to the target architecture, thus transforming the legacy system into a component-based system.

With reference to FIG. 1, the concept of the present invention is described through a planning process 110 of deriving an architecture that is considered to be ideal after a reengineering, a reverse engineering process 120 of analyzing legacy information during analysis, design and implementation processes, which are different abstraction levels of the system, with respect to an actual legacy system, a componentization process 130 of establishing the architecture for a target system, extracting components from legacy system information and developing the components, and a component-based development process 140 of assembling and arranging the components to be suitable for an actual target environment and managing the assembled and arranged components.

First, the planning process 110, which determines whether to perform a reengineering project and determining the strategy and processes required to perform the reengineering project through the understanding of the task analysis of the legacy system and the requirements of reengineering, presents an ideal architecture capable of considering a business area. Further, the reverse engineering process 120 extracts and analyzes analysis information, design information and implementation information of the legacy system, and processes the extracted information in a more abstract form. That is, the abstracted information is recovered in the order of the lowest level-source model, a functional model and an architecture model. The source model analyzes program source code, generates text and Abstract Syntax Tree (AST) information, and identifies the code patterns of the legacy system. The functional model represents the structural diagrams of system and data, which are more abstracted design information, and a workflow process which performs a single logic. The architecture model represents components (sub-systems), which are pieces of information further abstracted through a procedure of grouping and filtering the functional model, and interfaces between the components.

The componentization process 130, which actually transforms the legacy system into the target system to be constructed, supports transformation processes corresponding to the capabilities of an organization at various levels of the reverse engineering. A code-style transformation, which is the lowest level transformation, supports only a transformation between program languages. The functional model transformation is exemplified by wrapping and DB schema transformation. The architecture transformation is the process of transforming legacy system architecture into new architecture. In particular, the component-based development proposes a method of connecting to a conventional forward engineering methodology, such as Rational Unified Process (RUP), at various transformation levels as the occasion demands.

That is, the methodology of the present invention includes the reverse engineering process comprised of activities that analyze and understand the information of the legacy system and abstract the analyzed information to more valuable semantics, the componentization process of transforming the forms of information into other forms having the same level according to each abstraction level, and the architecture-based development process of performing forward engineering development toward a new component-based system. That is, since the legacy system is transformed into the component-based system through the transition of architecture from various standpoints of reengineering, the methodology of the present invention is referred to as an architecture-based reengineering methodology for reengineering the legacy system.

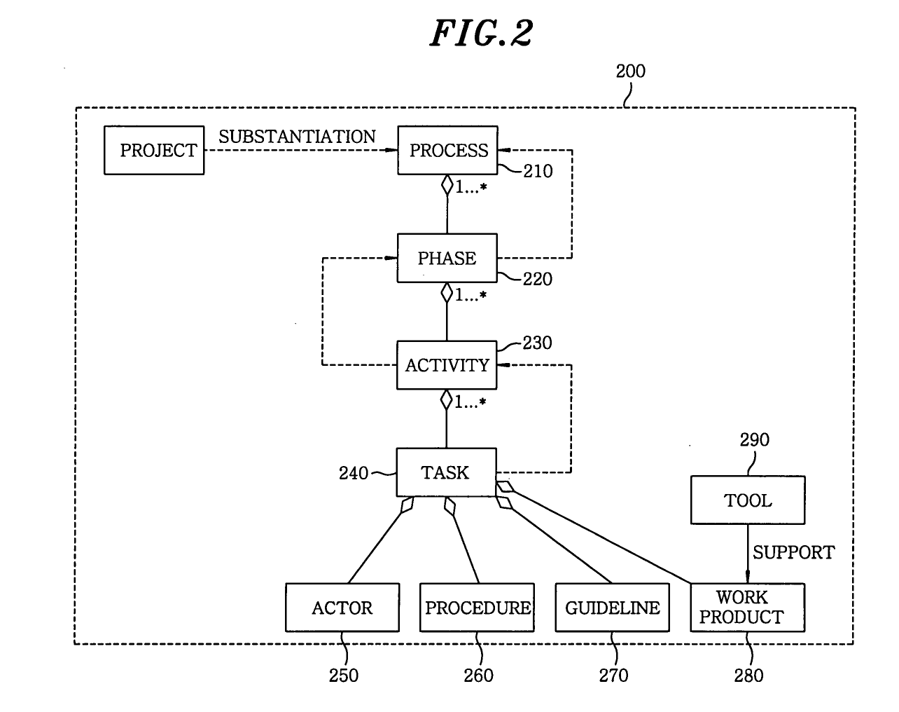

FIG. 2 illustrates a meta model 220 to express the concept of FIG. 1 as a methodology, in which constituents constituting the methodology and procedures of performing a reengineering project are logically expressed. The reengineering project can be substantiated through a process 210, which includes a plurality of phases 220 that are logical sections of the reengineering process. Further, each of the phases 220 includes a plurality of activities 230, and each of the activities 230 is a sequential set of tasks systematized to achieve the specific object of the reengineering. Each of the activities 230 includes a plurality of tasks 240 each indicating a work having a single function that can be selectively performed. The tasks 240 included in each activity may be omitted or selectively performed from a plurality of available candidate tasks according to the characteristics and states of the tasks. Each of the tasks 240 includes actors 250 indicating the subjects of actions, detailed procedures 260 that can be selectively performed, guidelines 270 specifying items to be noted in corresponding tasks and examination elements to be essentially achieved, and work products 280 produced as results of the performance of detailed roles and tasks. Further, tools 290 are used for efficient progress at the time of producing work products. Therefore, the reengineering project can be achieved through the execution of the process comprised of detailed procedures and guidelines of the reengineering process, a plurality of tasks of producing work products according to the procedures and guidelines, higher activities integrating the tasks, and the phases, which are sets of activities.

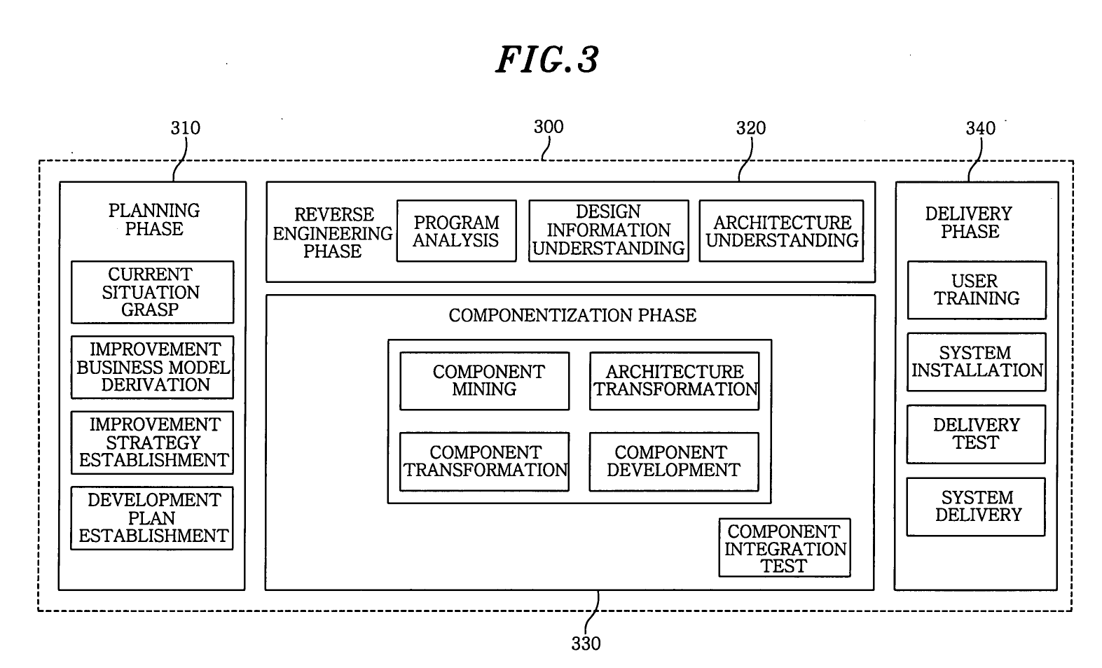

FIG. 3 illustrates a view showing 4 phases and 16 activities constituting the entire process 300 of the reengineering methodology proposed in the present invention.

With reference to FIG. 3, reference numeral 310 denotes a planning phase, which determines whether to perform a reengineering project and establishes the ideal improved architecture of a legacy business area to be referred to through reengineering. Further, in the planning phase 310, optimal strategy and process for the performance of the reengineering are set up and a development plan is established.

Reference numeral 320 denotes a reverse engineering phase, in which pieces of system information about development and management included in the legacy system and pieces of semantic information related to business are recovered at analysis, design and code levels that are classified according to abstraction levels based on the lifespan of the legacy system.

Reference numeral 330 denotes a componentization phase, which performs a transformation into a target system to be achieved through reengineering on the basis of the information obtained through the phases 310 and 320. In this operation, components are extracted on the basis of the work of the legacy system and the sub-systems of the program, the architecture of the target system is established on the basis of the strategy established in the planning process 110 and information analyzed in the reverse engineering process 120, and actual individual components are designed, implemented and tested to correspond to the architecture. Finally, the implemented components are assembled to correspond to the target architecture in the component-based development process 140, thus completing the target system.

Moreover, reference numeral 340 denotes a delivery phase that verifies whether the completed target system and components satisfy the user's requirements, and that transfers and delivers the results to the user. In accordance with the present invention, the delivery phase 340 has a procedure and technique identical to that of the conventional forward engineering methodology, so that a detailed description thereof is omitted.

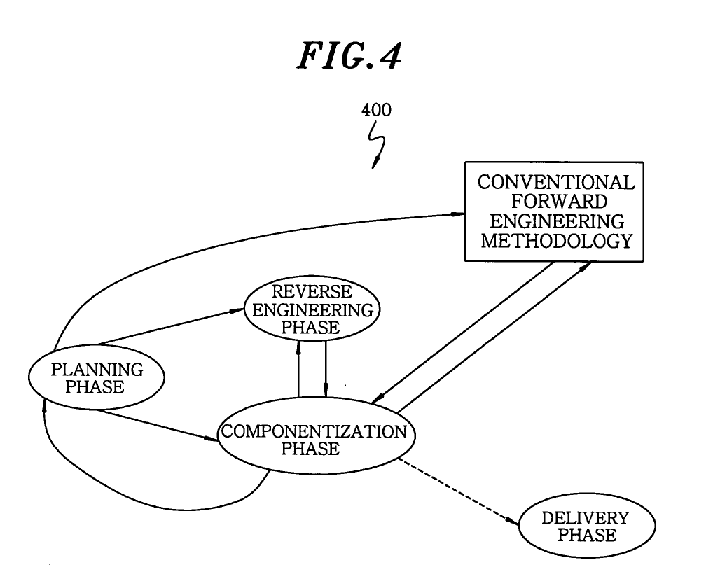

FIG. 4 illustrates the basic process 400 of the reengineering methodology proposed in the present invention. In the reengineering methodology, the analysis of the requirements of users (developer with a reengineering methodology and client desiring to utilize the reengineering methodology) and environmental conditions are very important, and the target and strategy of the reengineering are differently applied according to the situations of the client, so that the reengineering methodology must effectively cope with continuous maintenance and evolution. Therefore, a procedure of transmitting intentions between users until the users' requirements are definitely verified should be guaranteed, and the performance of feedback and repeated phases to accommodate environmental and functional variations should also be guaranteed.

The present invention defines the methodology to customize a reengineering process in parallel and selectively, unlike a sequential or synchronized development process provided by conventional methodologies, thus supporting continuous expansion, assembly and customization process on the basis of target architecture. That is, the componentization phase can be performed after the reengineering phase is performed according to a reengineering strategy established in the planning phase and the process thereof. Or the componentization phase can be directly performed, and the reengineering phase is performed thereafter if necessary, thus obtaining pieces of required information. Further, the componentization phase and the delivery phase produce required work products with reference to activities and tasks, provided from the conventional forward engineering methodology, and perform a forward engineering development task. Further, in order for reengineers to actually develop their projects using MaRMI-RE, the methodology of the present invention provides different reengineering scenarios according to the current situations of an organization, thus supporting the customization of an optimal process.

TABLE 1

| Type | Scenario | Description |
|---|---|---|
| 1 | plan | This scenario may proceed to the componentization |
| | ↓ | phase after all tasks of the reverse engineering |
| | reverse engineering | phase have been completed, but the scenario may |
| | ↓ ↑ | proceed to the componentization phase after only |
| | componentization | a selected reverse engineering task is performed, |
| | ↓ | and, if necessary, the scenario may be fed back |
| | delivery | to the activities and tasks of the reverse |
| | | engineering phase to perform corresponding tasks. |
| 2 | plan | After this scenario first proceeds to the |
| | ↓ | componentization phase, componentization is |
| | componentization | executed while a task of feeding required |
| | ↓ ↑ | information back from the reverse engineering |
| | reverse engineering | phase and obtaining the required information |
| | ↓ | during componentization tasks is repeatedly |
| | componentization | performed. |
| | ↓ | |
| | delivery | |
| 3 | plan | After this scenario directly proceeds to the |
| | ↓ | componentization phase without the tasks of the |
| | componentization | reverse engineering phase, required activities of |
| | ↓ | conventional forward engineering methodology, |
| | conventional forward | such as MaRMI-III, are performed so as to generate |
| | engineering methodology | newly required business components, and the |
| | ↓ | results thereof are integrated with the work |
| | componentization | products of the componentization phase, thus |
| | ↓ | performing the project. |
| | delivery | |
| 4 | plan | At the primary analysis of the planning phase, if |
| | ↓ | most parts must be newly changed without being |
| | conventional forward | greatly influenced by the legacy system, required |
| | engineering methodology | components are first generated through the tasks |
| | ↓ | of the conventional forward engineering |
| | componentization | methodology, such as MaRMI-III, and then this |
| | ↓ | scenario proceeds to the componentization phase, |
| | delivery | so that componentization tasks based on the |
| | | vision and strategy of the reengineering project |
| | | are performed. |
| 5 | plan | Combination of type 1 and type 3, which is used |
| | ↓ | when the target system requires businesses other |
| | reverse engineering | than businesses included in the category of the |
| | ↓ | legacy system. |
| | componentization | pieces of information about the legacy system |
| | ↓ | are collected through the reverse engineering |
| | conventional forward | phase according to the vision and transformation |
| | engineering methodology | strategy established in the planning phase, newly |
| | ↓ | added businesses are generated through the |
| | componentization | conventional forward engineering methodology |
| | ↓ | process, such as MaRMI-III, during the |
| | delivery | componentization phase, and then the |
| | | componentization phase is performed again to |
| | | execute a procedure of integrating the newly |
| | | generated businesses with existing components |
| | | under the componentization strategy. |
| 6 | plan | The reengineering project established in the |
| | ↓ | planning phase is executed by performing a |
| | reverse engineering & | procedure of integrating obtained component |
| | conventional forward | information with components of newly added |
| | engineering methodology | businesses in the componentization phase, after |
| | ↓ | the components of newly added businesses are |
| | componentization | generated through the tasks of conventional |
| | ↓ | forward engineering methodology, such as MaRMI- |
| | delivery | III, at the same time that information on |
| | | components to be extracted from the resources of |
| | | the legacy system are obtained through the |
| | | reverse engineering phase. |

The Table 1 summarizes examples of individual development scenarios to customize the basic process 400 in brief according to the present invention.

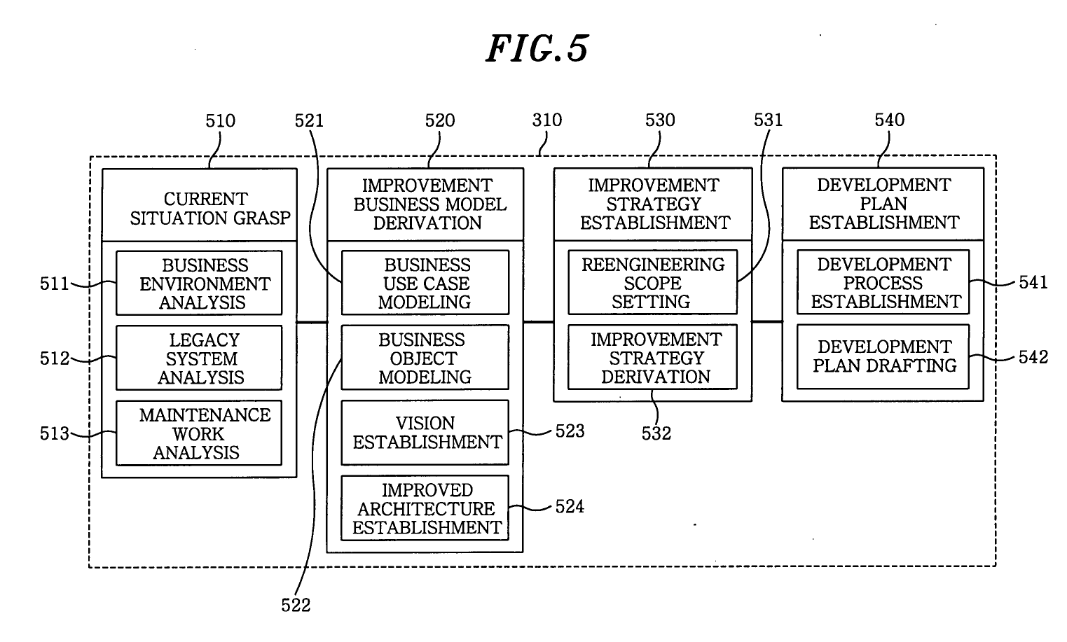

FIG. 5 illustrates the activities and tasks of the planning phase 310 of FIG. 3 in detail.

The planning phase is to determine whether to proceed to componentization through the entire analysis of the legacy system, and to present a reengineering direction for subsequent phases. A management class desires to minimize the investment of cost and obtain maximum added value. Therefore, deep analysis and prediction of expected quality and determination of whether productivity is improved are required. From this point of view, the phase is comprised of 4 activities and 11 tasks, as shown in FIG. 5. Through the tasks, problems of the legacy system are grasped, a business direction to go forward is analyzed to determine a suitable improvement direction, and the purpose, target and scope of a project are fixed, thus drafting a development plan, which is the final work product of the planning phase.

With reference to FIG. 5, a current situation grasping activity 510 is to grasp the configuration of an organization, the workflow and the greatest issues that the organization faces, through the analysis of entire and general information about the work, and to understand the function of the work and the functions of sub-systems for each work unit. Further, the current situation grasping activity 510 is to analyze information about the maintenance and management of the legacy system, and present the basic data for the establishment of the reengineering strategy later.

The purposes, detailed procedures and work products of three tasks 511, 512 and 513 constituting the current situation grasping activity 510 are summarized in the Table 2.

TABLE 2

| Task | Summary | Procedure | Work product |
|---|---|---|---|
| Business | Configuration, culture, and | (1) organization | interview plan |
| environment | management characteristics | configuration | organization |
| analysis | of the organization are | grasp | configuration view |
| 511 | grasped in addition to a | (2) workflow grasp | work flowchart |
| | work process designated as | (3) internal issue | current situation |
| | the core capability of the | grasp | analysis report |
| | organization, and internal | | work |
| | issues and problems of the | | configuration view |
| | organization are derived | | |
| | from a business standpoint | | |
| | on the basis of the grasped | | |
| | characteristics. | | |
| Legacy | On the basis of the | (1) work function | legacy system |
| system | execution results of the | analysis | analysis report |
| analysis | business environment | (2) application | system |
| 512 | analysis task, an important | system analysis | environment |
| | application system | (3) system | analysis report |
| | supporting a work process | environment | system |
| | is grasped. For this | analysis | configuration view |
| | operation, the best person | | |
| | in charge of grasping the | | |
| | application system is | | |
| | selected and the function | | |
| | of the system is analyzed | | |
| | by the unit of work through | | |
| | an interview with the | | |
| | person. | | |
| Maintenance | Current maintenance | (1) current | maintenance work |
| work | situation for work being | maintenance | analysis report |
| analysis | currently managed and | situation grasp | |
| 513 | maintenance process are | (2) maintenance | |
| | analyzed to identify | problem analysis | |
| | problems with the | | |
| | maintenance and areas | | |
| | requiring improvement. | | |

The improvement business model derivation activity 520 of FIG. 5 is to clearly grasp the requirements of parties concerned with the activity through business use case modeling and business object modeling, and to present an improvement business model, which is to be a target later. On the basis of the improvement business model, the purpose and scope of the project are determined. The architecture generated in this case is the ideal model of the business area, which presents an aim to set architecture information recovery in the reverse engineering phase or the target architecture in the componentization phase that is a subsequent process.

The table 3 shows the detailed descriptions of detailed tasks 521 to 524 of the improvement business model derivation activity 520 of FIG. 5.

TABLE 3

| Task | Summary | Procedure | Work product |
|---|---|---|---|
| Business use | An ideal model for the work of | (1) business | business use |
| case modeling | the legacy system analyzed as a | use case | case diagram |
| 521 | problem is presented using a | identification | business use |
| | business use case model. | (2) use case | case |
| | | specification | specification |
| | | drafting | |
| Business | An object required to implement | (1) business | business object |
| object | a business use case is modeled | object | diagram |
| modeling 522 | using a logical model of | identification | |
| | business. | (2) object | |
| | | modeling | |
| Vision | Requirements of parties | (1) requirement | vision document |
| establishment | concerned with understanding | grasp | (requirements, |
| 523 | are clearly grasped and the | (2) project | project purpose |
| | purpose and scope of the | purpose and | and scope |
| | project are understood. | scope | definition) |
| Improved | Relations between distributed | (1) system | improved |
| architecture | system entities are defined on | architecture | architecture |
| establishment | the basis of the purpose and | definition | document |
| 524 | scope of the project and the | (2) software | (improved |
| | priority of business use case, | architecture | architecture, |
| | and procedures allocated to | definition | system |
| | each work are grasped, thus | | architecture, |
| | providing the basis of the | | software |
| | establishment of system | | architecture) |
| | improvement strategy. | | |

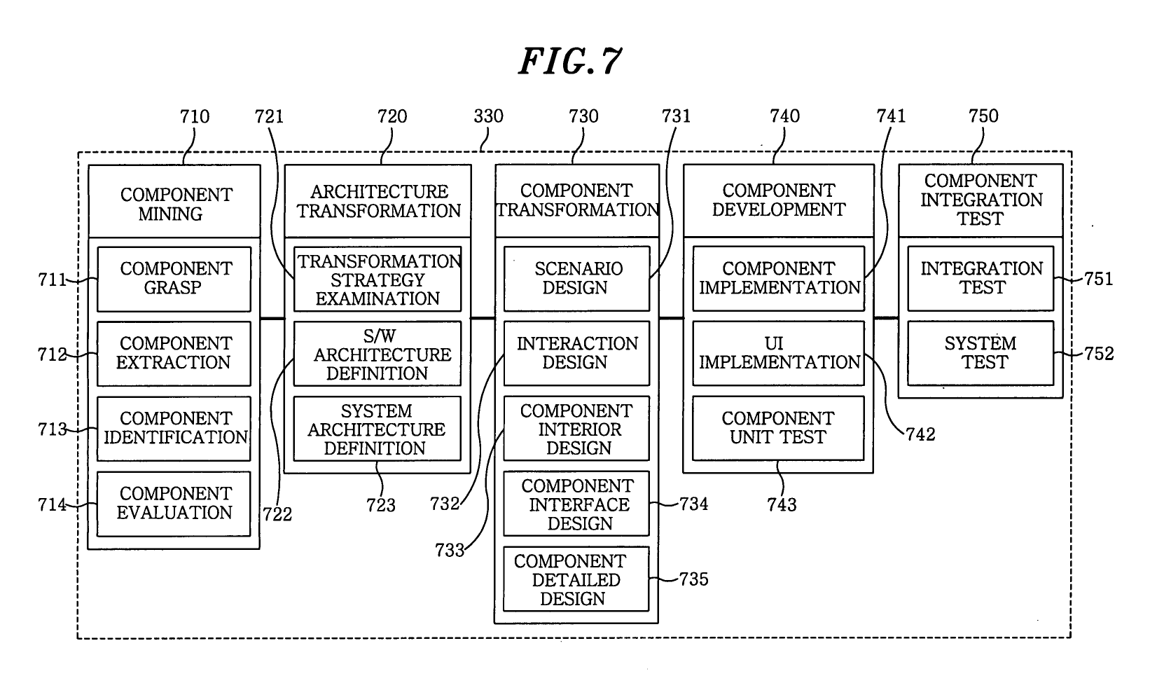

Next, reference numeral 530 of FIG. 5 is an improvement strategy establishment activity, which provides an optimal approaching method to perform a reengineering project. For this activity, object work to be improved is selected, and technical elements are analyzed from the standpoint of the business value and system for the work to determine reengineering priority, and an optimal transformation strategy for componentization is established with respect to each work unit. The strategy established here is compared to analysis results in an architecture transformation activity 720 of the componentization phase of FIG. 7, which will be described later, thus inducing a determination most suitable for the current situation of the organization.

TABLE 4

| Task | Summary | Procedure | Work product |
|---|---|---|---|
| Reengineering | Business elements and system | (1) reengineering | improvement |
| scope | elements to be taken into | element | strategy |
| selection 531 | consideration for | selection and | establishment |
| | componentization are determined | weight | report |
| | to select business elements and | assignment | |
| | system elements according to | (2) reengineering | |
| | work, and relative weights | object selection | |
| | according to item are assigned | | |
| | to respective elements and | | |
| | compared to each other, thus | | |
| | selecting a reengineering | | |
| | object. | | |
| Improvement | Improvement strategy about | (1) reengineering | improvement |
| strategy | whether work selected as the | object | strategy |
| derivation | reengineering object is to be | evaluation | establishment |
| 532 | componentized using | (2) improvement | report |
| | transformation or wrapping is | strategy | (refinement) |
| | derived. | determination | |

The Table 4 shows the contents of a reengineering scope selection task 531 and an improvement strategy derivation task 532, which are two tasks included in the activity 530.

The development plan establishment activity 540, which is the last activity constituting FIG. 5, is to select items of the procedure and work product of the methodology to be actually applied to the development by establishing a development process on the basis of a determined component transformation strategy, and to draft a development plan by collecting and arranging the work products obtained from previous tasks. In this case, for a reengineering scenario suitable for the user's requirement and the organization's capability based on the strategy determined through the activity 530, one of the scenarios derived from the basic process 300 of Table 1 is selected. Table 5 summarizes and describes tasks 541 and 542 constituting the planning phase of FIG. 5.

TABLE 5

| Task | Summary | Procedure | Work product |
|---|---|---|---|
| Development | By defining a subject, a time, an | (1) development | development |
| process | object and a method to process new | process | process |
| establishment | requirements or requirement | refinement | |
| 541 | changes, basic processes comprised | (2) gradual | |
| | of plan, reverse engineering, | technique | |
| | componentization and delivery | | |
| | phases are selected and adjusted | | |
| | depending on the user's requirement | | |
| | and development characteristics, | | |
| | thus establishing an optimal | | |
| | development process. | | |
| Development | Work products obtained during | (1) manpower | development |
| plan drafting | previous task process are | cost | plan |
| 542 | collected, arranged and | calculation | |
| | complemented to draft a development | (2) development | |
| | plan in which a work list, a work | plan drafting | |
| | execution method, etc. are | | |
| | concretized, so as to effectively | | |
| | achieve a target during a project | | |
| | period. | | |

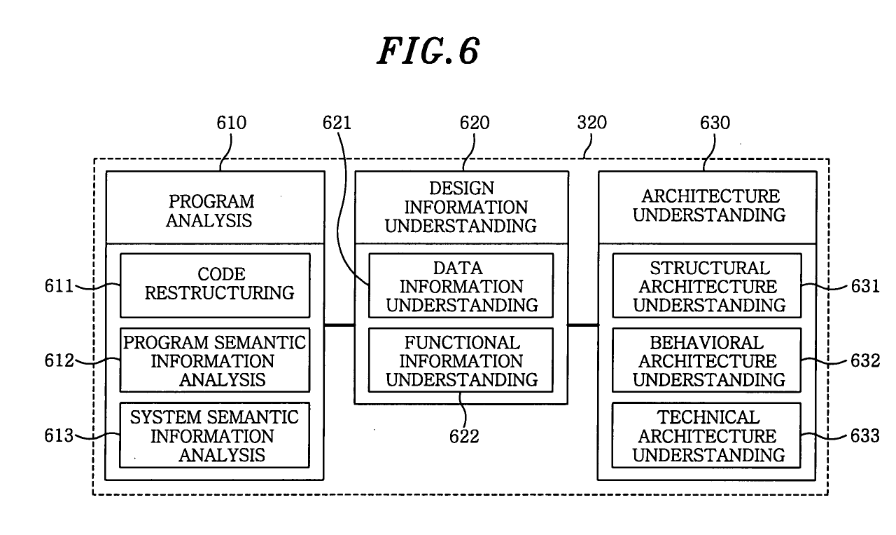

FIG. 6 illustrates a view showing the activities and tasks of the reverse engineering phase 320 of FIG. 3 in detail. This phase is to improve the understanding of static and dynamic action information for the legacy system by analyzing the work products of the legacy system. Therefore, architecture information is understood and abstracted through the recognition of relations between the elements of the legacy system, so that a preparation task for componentization is performed, and a modeling task for abstracting the analysis results of the semantics of codes in the form of design information is performed.

TABLE 6

| Task | Summary | Procedure | Work product |
|---|---|---|---|
| Code | Program logics are | (1) code restructuring | structured |
| restructuring | restructured to attempt to | object identification | legacy code |
| 611 | improve the understanding | (2) replacement by | |
| | of the legacy system and | structured code | |
| | the productivity of | (3) duplicated | |
| | reengineering. | module/dead code | |
| | | elimination | |
| | | (4) code reformat and | |
| | | evaluation | |
| Program | Data information, program | (1) program syntax | variable |
| semantic | configuration information, | analysis | relation |
| information | and control flow of | (2) variable | table |
| analysis 612 | individual programs are | information grasp | subroutine |
| | analyzed, and code patterns | (3) unit program | call |
| | repeatedly used in legacy | semantic information | information |
| | codes are identified, thus | grasp | subroutine |
| | improving the understanding | (4) code pattern | control flow |
| | of legacy system. | analysis | information |
| System | Control flow, reference | (1) data model | system |
| semantic | information, call | information | resource |
| information | relationship information, | generation | graph/table |
| analysis 613 | and hierarchical structures | (2) system resource | program |
| | between programs | information grasp | call |
| | constituting the entire | (3) grasp of call | graph/table |
| | legacy system are grasped | information between | screen flow |
| | as the semantic information | programs | graph/table |
| | ranging over the entire | (4) grasp of reference | |
| | legacy system. | information between | |
| | | programs and files | |

With reference to FIG. 6, a program analysis activity 610 represents the typical reverse engineering process of the legacy system. Therefore, the syntax information and semantic information of the legacy program are analyzed and extracted at system level and unit program level through code restructuring and source code analysis, and pieces of analyzed information are normalized using a relationship diagram between data and control flows, a call graph between modules, etc. In this activity, efficiency can be increased through the use of automated tools. A code restructuring task 611, a program semantic information analysis task 612, and a system semantic information analysis task 613, which are three tasks constituting the activity, are summarized and described in the Table 6.

TABLE 7

| Task | Summary | Procedure | Work product |
|---|---|---|---|
| Data | Information on main data | (1) object | entity |
| information | structures constituting the | information | relationship |
| understanding | legacy system is extracted, | extraction | database |
| 621 | thus supporting the efficient | (2) relationship | schema |
| | understanding of the static | information | |
| | structure of the legacy | extraction | |
| | system. | (3) super/sub-type | |
| | | information | |
| | | extraction | |
| | | (4) entity | |
| | | relationship | |
| | | diagram drafting | |
| | | (5) database schema | |
| | | drafting | |
| Functional | A set of screens representing | (1) use case | application |
| information | task flow is extracted by the | modeling | use case |
| understanding | unit of one application use | (2) mapping table | diagram |
| 622 | case, and the extracted | drafting | application |
| | information is allowed to | (3) functional | use case |
| | correspond to business use | relationship | correspondence |
| | case information extracted in | diagram drafting | table |
| | the planning phase, thus | | functional |
| | understanding functional | | relationship |
| | information of entire system. | | diagram |

Further, a design information understanding activity 620 of FIG. 6 is to identify functional unit processes on the basis of program analysis information, specify control flow between the unit processes and data flow between the unit processes and related tables, and provide system design information for architecture understanding, which is a subsequent activity. This activity is used to obtain higher understanding by modeling the design information of the legacy system and abstracting the modeling results in the form of a structural diagram. The design information understanding activity 620 is comprised of two tasks 621 and 622, the summary features of which are described in the TABLE 7.

TABLE 8

| Task | Summary | Procedure | Work product |
|---|---|---|---|
| Structural | Modules, which are elements | (1) system hierarchy | structural |
| architecture | constituting the legacy | grasp | architecture |
| understanding | system, are further | (2) sub-system | |
| 631 | abstracted and identified | identification | |
| | by the unit of independent | (3) grasp of | |
| | component (sub- system), | dependence between | |
| | and interdependence between | sub-systems | |
| | the elements is expressed. | (4) structural | |
| | | architecture drafting | |
| Behavioral | How call relations between | (1) grasp of | behavioral |
| architecture | components are made is | dependence between | architecture |
| understanding | understood on the basis of | sub-systems | |
| 632 | sub-systems or components | (components) | |
| | constituting the structural | (2) behavioral | |
| | architecture so as to grasp | architecture drafting | |
| | the entire behavior of the | | |
| | legacy system. | | |
| Technical | Information about which | (1) constitution | technical |
| architecture | technologies are applied to | hardware grasp | architecture |
| understanding | develop equipment | (2) component (sub- | |
| 633 | constituting the legacy | system) arrangement | |
| | system and components | (3) definition of | |
| | arranged in the equipment, | technology applied to | |
| | and how they have been | sub-systems | |
| | developed is expressed. | (4) technical | |
| | | architecture | |
| | | definition | |

Next, the architecture understanding activity 630 of FIG. 6 is to improve the understandability for the legacy system through information recovery for structural architecture, technical architecture and behavioral architecture constituting the legacy system. The features of the architecture understanding activity comprised of 3 tasks 631, 632 and 633 and 10 procedures are summarized in the Table 8 and presented therein.

FIG. 7 illustrates a view showing the activities and tasks of the componentization phase 330 of FIG. 3 in detail. This phase groups parts with higher relevance and identifies the grouping results as component candidates so as to componentize system entities with higher semantic relevance on the basis of the information extracted through the reverse engineering process in the legacy system. Further, the reengineering method of the legacy system and the strategy for successfully performing the reengineering method are determined, and S/W, component and system architectures are defined to componentize extracted reusable components. Further, the interfaces of the extracted components are identified, the static and dynamic structures of the interior of the components are created, and the static and dynamic structures are transformed into system-manageable programs newly defined on the basis of system architecture.

With reference to FIG. 7, a component mining activity 710 is used to execute a task of transforming the legacy system into a system having new architecture. Therefore, the legacy system is divided into several parts according to units performing a business function, and the division parts are allowed to correspond to respective components and then grasped and extracted. For this operation, in order to extract a unit performing a single business function from the legacy system, there is established a method of grouping system entities with higher semantic relevance on the basis of the system information extracted in the reverse engineering process, recognizing the grouping results as component candidates, evaluating the extracted component candidates on the basis of a component utility strategy, and then utilizing the evaluated component candidates for a new system. The Table 9 summarizes the tasks 711 to 714 and detailed procedures of the component mining activity.

The architecture transformation activity 720 of FIG. 7 is to confirm a method of reengineering the legacy system and a strategy of successfully performing the reengineering, and fixing a technique of componentizing the extracted reusable components. For this activity, reengineering requirements are analyzed, so that a new environment, which is to be a target for the reengineering system, is defined. Further, the S/W architecture of the reengineering system is remodeled, the component architecture for business components is designed through interaction modeling, and system architecture including technical architecture is defined.

TABLE 9

| Task | Summary | Procedure | Work product |
|---|---|---|---|
| Component | Component candidates | (1) use case | interrelation |
| grasp 711 | performing independent | related system | modeling table |
| | business functions are | entity grasp | use case |
| | selected, and system | (2) use case | analysis table |
| | entities constituting | analysis | component entity |
| | each of the candidates | (3) component | description |
| | are traced and grasped | candidate grasp | report |
| | with respect to each | | |
| | candidate. | | |
| Component | Components are extracted | (1) sharing element | component list |
| extraction 712 | on the basis of the | grasp | table |
| | system entities | (2) component | component |
| | constituting each | extraction | interaction table |
| | component, and | (3) grasp of | component entity |
| | interrelations and | interrelations/ | description |
| | interactions | interactions | report |
| | therebetween are | between components | (refinement) |
| | grasped. | | application use |
| | | | case/component |
| | | | correspondence |
| | | | table |
| Component | Components performing | (1) component | component entity |
| identification | independent functions | candidate grasp | description |
| 713 | not included in the | (2) component | report |
| | legacy system are | extraction | component list |
| | identified as components | | table |
| | and extracted on the | | component |
| | basis of business use | | interaction table |
| | cases constructed in the | | business use |
| | planning phase. | | case/component |
| | | | correspondence |
| | | | table |
| Component | A utility method related | (1) establishment | component list |
| evaluation 714 | to how the extracted | of component | table |
| | components are to be | utility strategy, | (refinement) |
| | utilized is established | and evaluation | component |
| | and evaluated, in which | criteria for | interaction table |
| | interrelations and | utility strategy | (refinement) |
| | interactions between | (2) component | {application use |
| | components are | evaluation | case/component |
| | readjusted/the system is | (3) readjustment of | correspondence |
| | expressed on the basis | interrelations/ | table} or |
| | of the interrelations | interactions | {business use |
| | between the extracted | between components | case/component |
| | components. | | correspondence |
| | | | table} |

Tasks 721, 722 and 723 constituting the architecture activity are summarized and described in Table 10.

The component transformation activity 730 of FIG. 7 is to identify the interfaces of extracted components, design the internal structure of the components, and identify the operations of the component interfaces on the basis of dynamic message flow information between the internal classes of the components. The detailed procedures and main work products of the activity 730 comprised of five tasks 731 to 735 are summarized in the Table 11.

TABLE 10

| Task | Summary | Procedure | Work product |
|---|---|---|---|
| Transformation | Reengineering scope and | (1) transformation | transformation |
| strategy | method are determined, | strategy and | strategy |
| examination | strategy and technique of | component utility | examination |
| 721 | componentizing extracted | strategy | report |
| | components are defined, | comparison/analysis | improvement |
| | and the appropriateness | (2) transformation | strategy |
| | thereof is examined. That | strategy | establishment |
| | is, reengineering | readjustment | report |
| | requirements and | (3) refinement of | (refinement) |
| | transformation types are | improvement | |
| | analyzed, and | strategy | |
| | transformation strategy is | establishment | |
| | established. | report of target | |
| | | system | |
| Software | Pieces of architecture | (1) architecture | architecture |
| architecture | analysis information | analysis | information |
| definition 722 | obtained from various | information | analysis report |
| | standpoints are examined | examination | architecture |
| | to identify the functional | (2) definition of | functionality |
| | requirements and quality | functional | list table |
| | attributes of a target | requirements of | architecture |
| | system, and the | target system | quality |
| | architecture structure of | (3) quality | attributes list |
| | the target system is set, | attribute | table |
| | thus defining the software | derivation | quality |
| | architecture of the target | (4) architecture | scenario |
| | system. | structure setting | |
| | | (5) software | |
| | | architecture | |
| | | definition | |
| System | The technical architecture | (1) technical | technical |
| architecture | and component architecture | architecture | architecture |
| definition 723 | of the target system are | definition | component |
| | defined, and defined | (2) component | architecture |
| | components are arranged in | architecture | system |
| | a physical environment, | definition | architecture |
| | thus deriving the system | (3) system | |
| | architecture of the target | architecture | |
| | system. | definition | |

TABLE 11

| Task | Summary | Procedure | Work product |
|---|---|---|---|
| Scenario | Scenarios of a task flow | (1) drafting of normal | use case |
| design 731 | related to how respective | scenario according to | specification |
| | use cases identified in the | use case | |
| | plan and reverse | (2) drafting of | |
| | engineering phases must be | selective scenario | |
| | operated in a new target | according to use case | |
| | system are analyzed and | (3) drafting of | |
| | designed. | exceptional scenario | |
| | | according to use case | |
| Interaction | Which interaction is | (1) use case selection | component |
| design 732 | performed between entities | and actor placement | interaction |
| | in order for each use case | (2) object or entity | diagram |
| | to perform a corresponding | arrangement | |
| | task in the system is | (3) message | |
| | modeled on the basis of | identification | |
| | information of use cases | (4) interaction | |
| | and entities. | diagram drafting | |
| Component | Internal elements of each | (1) class extraction | class diagram |
| interior | component are identified, | (2) method and | component |
| design 733 | and the internal structures | attribute grasp | diagram |
| | of the component are | (3) relation setting | |
| | designed. | (4) class allocation | |
| | | according to | |
| | | component | |
| Component | Services to be provided | (1) use case-based | component |
| interface | according to component are | interface | specification |
| design 734 | defined by grasping | identification | component |
| | interfaces thereof, and | (2) data-based | diagram |
| | required services according | interface | (refinement) |
| | to interface are extracted | identification | |
| | through operations. | (3) interface | |
| | | refinement | |
| | | (4) interface details | |
| | | (5) component details | |
| Component | In order to describe | (1) packaging | component |
| detailed | components in detail in | definition | detailed |
| design 735 | conjunction with a specific | (2) EJB mapping | design report |
| | platform (J2EE), mapping to | definition | |
| | beans and interfaces are | (3) continuity design | |
| | defined, and the design of | (4) transaction design | |
| | parts related to | (5) security design | |
| | continuity, transaction and | (6) arrangement design | |
| | security is performed. | | |

The component development activity 740 of FIG. 7 is to implement applications to comply with a component platform on the basis of the component detailed design information (implementation class model design report, transaction design report, security definition report, package definition report, arrangement description report, etc.). That is, through the use of the pieces of design information extracted through the component transformation activity 730, components are mapped to comply with an implementation technology platform and then implemented thereby. A unit test is carried out for each of the implemented components.

The component development activity 740 is comprised of three tasks 741, 742 and 743, and the detailed procedures and work products thereof are presented in the Table 12.

TABLE 12

| Task | Summary | Procedure | Work product |
|---|---|---|---|
| Component | A plurality of elements | (1) component | component |
| implementation | (interface, bean class, | implementation | source code |
| 741 | internal class, and main key | (2) component | |
| | class) constituting each | packaging | |
| | component is developed to | | |
| | comply with a corresponding | | |
| | platform on the basis of | | |
| | development standard or | | |
| | technology, and a method | | |
| | defined in the interface and | | |
| | class methods existing in the | | |
| | component are implemented. | | |
| UI | After UI screen is | (1) screen | UI source code |
| implementation | implemented for a screen to | design | UI execution |
| 742 | be displayed, the UI screen | (2) component | code |
| | is allowed to interwork with | interworking | |
| | components. | implementation | |
| Unit test 743 | A test is carried out with | (1) unit test | unit test |
| | respect to each of developed | plan | design report |
| | components, and classes in | (2) unit test | unit test |
| | each component are also | execution | execution report |
| | tested. | (3) unit test | corrected |
| | | evaluation | component source |
| | | | code |
| | | | unit test |
| | | | result report |

Finally, the component integration test activity 750 of FIG. 7 is to integrate developed individual components with each other through the construction of prototyping, thus determining whether the entire functionality of the legacy system is exhibited, and analyzing and examining restriction items. For this activity, extracted components are arranged on the architecture of the reengineering system and integrated with each other on the basis of a transaction strategy, thus examining whether the implemented components normally communicate with other components. Further, whether the component architecture and business requirements are sufficiently defined and implemented is examined.

TABLE 13

| Task | Summary | Procedure | Work product |
|---|---|---|---|
| Integration | During the process of | (1) test plan definition | integration |
| test 751 | integrating | (2) test example and data | test design |
| | respective | development | report |
| | transformed | (3) test procedure definition | integration |
| | components and | according to test example | test execution |
| | constructing a | (4) integration test | report |
| | system, whether | auxiliary program creation | integration |
| | component interfaces | (5) component integration and | test result |
| | between related | test | report |
| | components implement | (6) error correction and | |
| | a business logic as | recurrence test | |
| | defined in the system | (7) integration test result | |
| | design process is | summary | |
| | tested. | (8) integration test result | |
| | | investigation and approval | |
| System test | This process is to | (1) test plan definition | system test |
| 752 | obtain the formal | (2) test environment check | design report |
| | approval of a | (3) test example and data | system test |
| | developer of a | development | execution |
| | software product, and | (4) test procedure definition | report |
| | to examine whether | according to test example | system test |
| | the developed system | (5) creation of auxiliary | result report |
| | satisfies the | program for system test | |
| | functional and | (6) system test execution | |
| | technical quality | (7) error correction and | |
| | requirements. | recurrence test | |
| | | (8) system test result | |
| | | summary | |
| | | (9) test result investigation | |
| | | and approval | |

Especially, the component integration test activity 750 is a part having many interaction tasks with the conventional forward engineering methodology, together with the component transformation activity, and the detailed task procedures thereof are summarized in the Table 13.

In accordance with the present invention, it is possible to solve the limitations of conventional methodologies of reengineering a legacy system, that is, a difference between the legacy system and a target system occurring when the business area information is not reflected in an analysis task based on program source code, a problem related to repeated trial and error caused by the subjective determination of a reengineer at the time of decision of important items for reengineering strategy and project execution, the absence of customization capability to perform a reengineering process in parallel, repeatedly or selectively for an organization, and the insufficiency of guidelines required for detailed reengineering procedures and techniques. Therefore, the present invention is advantageous in that an organization recognizes a legacy system thereof as a reusable asset, and the creation of continuous values can be performed on the basis of a component system even though business and technical environments related to the system are changed.

In particular, the present invention is advantageous in that it presents a core reengineering process, detailed procedures and guidelines thereof, and work products required to execute the reengineering process, so that organizations intending to perform reengineering can utilize the process, detailed procedures and guidelines, and work products as ideal reference tools to obtain the reengineering effect that the organizations expect.

Further, the present invention is advantageous in that the ideal work architecture is established and set to a target object, the architecture information in the legacy system is recovered through a reengineering phase, and actual target architecture capable of maximally reflecting the capability of an organization is established through a componentization phase, so that the process of a reengineering methodology based on the transformation of architecture is executed. Therefore, the system allows flexible evolution with respect to unexpected potential change requirements, thus effectively providing a client's desired system service at a suitable time, and remarkably reducing the system maintenance cost that the organization must bear. Consequently, the present invention is advantageous in that it can realize high quality and high productivity pursued in the maintenance and evolution of the legacy system on the basis of the stability and reliability of existing systems.

While the invention has been shown and described with respect to the preferred embodiment, it will be understood by those skilled in the art that various changes and modifications may be made without departing from the spirit and scope of the invention as defined in the following claims.

1. A componentization method for reengineering a legacy system, comprising:
a) a planning phase of establishing a componentization strategy and a process plan of the legacy system for the reengineering;
b) a reverse engineering phase of analyzing program information of the legacy system and recovering functional information and architecture information;
c) a componentization phase of extracting components from the legacy system, establishing target architecture, and designing and implementing components to comply with the target architecture; and
d) a delivery phase of delivering transformed components which a user has approved after a forward engineering method.

2. The componentization method of claim 1, wherein the planning phase a) includes a current situation grasping activity, an improvement business model derivation activity, an improvement strategy establishment activity, and a development plan establishment activity.

3. The componentization method of claim 2, wherein the current situation grasping activity includes a business environment analysis task, a legacy system analysis task, and a maintenance work analysis task.

4. The componentization method of claim 2, wherein the improvement business model derivation activity includes a business use case modeling task, a business object modeling task, a vision establishment task, and an improved architecture establishment task.

5. The componentization method of claim 2, wherein the improvement strategy establishment activity includes a reengineering scope setting task, and an improvement strategy derivation task.

6. The componentization method of claim 2, wherein the development plan establishment activity includes a development process establishment task, and a development plan drafting task.

7. The componentization method of claim 1, wherein the reverse engineering phase b) includes a program analysis activity, a design information understanding activity, and an architecture understanding activity.

8. The componentization method of claim 7, wherein the program analysis activity includes a code restructuring task, a program semantic information analysis task, and a system semantic information analysis task.

9. The componentization method of claim 7, wherein the design information understanding activity includes a data information understanding task, and a functional information understanding task.

10. The componentization method of claim 7, wherein the architecture understanding activity includes a structural architecture understanding task, a behavioral architecture understanding task, and a technical architecture understanding task.

11. The componentization method of claim 1, wherein the componentization phase c) includes a component mining activity, an architecture transformation activity, a component transformation activity, a component development activity, and a component integration test activity.

12. The componentization method of claim 11, wherein the component mining activity includes a component grasping task, a component extraction task, a component identification task, and a component evaluation task.

13. The componentization method of claim 11, wherein the architecture transformation activity includes a transformation strategy examination task, a software (S/W) architecture definition task, and a system architecture definition task.

14. The componentization method of claim 11, wherein the component transformation activity includes a scenario design task, an interaction design task, a component interior design task, a component interface design task, and a component detailed design task.

15. The componentization method of claim 11, wherein the component development activity includes a component implementation task, a User Interface (UI) implementation task, and a component unit test task.

16. The componentization method of claim 11, wherein the component integration test activity includes an integration test task and a system test task.
